(19) United States
(12) Patent Application Publication
(10) Pub. No.: US 2017/0199938 A1
(43) Pub. Date: Jul. 13, 2017

(54) Pushing Content to Digital Frames Based on Personal Artistic Taste

(71) Applicant: International Business Machines Corporation, Armonk, NY (US)

(72) Inventors: Taylor L. Franklin, Austin, TX (US); Nathan T. Hekman, Austin, TX (US); Florian Pinel, New York, NY (US); Brian L. White Eagle, Austin, TX (US)

(73) Assignee: International Business Machines Corporation, Armonk, NY (US)

(21) Appl. No.: 14/993,204

(22) Filed: Jan. 12, 2016

(51) Int. Cl. G06F 17/30

(52) U.S. Cl. CPC G06F 17/30867; G06F 17/3087

(57) ABSTRACT

Digital media content is provided to users based on assumptions about their personal artistic tastes that may be made based on the interactions of the users with objects in the environment. Particular objects are determined to be of interest based on the interaction of the user with the artwork through data collected on site and then provided to a remote server. The remote server uses the object information and user interaction to search and retrieve digital media content that is likely to be of interest to the user based on how the user has physically interacted with object. The relevant digital content may then be automatically delivered to a digital display device of the user, such as a computer, a screen saver, a mobile device, an online storage system, a wireless photo frame, or wireless television.

### BACKGROUND

The present invention relates to digital media delivery and, more specifically, to a method of providing digital media content to users based on their personal artistic tastes.

A user of digital media typically has to select and download desired media for display on user devices, such as wireless digital frames. Devices such as wireless digital frames can display pictures from a variety of online storage providers but the content is necessarily limited to images or other media that have been previously acquired and uploaded by the user to the service supporting the digital frame. Additionally, such systems are unable to automatically identify digital media content that are likely of interest to the user, and thus require the user to manually search for relevant content. Accordingly, there is a need in the art for a system and method that can identify and readily push content to the user without the need for the user to specifically search, select and download the desired content.

### SUMMARY

In one embodiment of the invention, digital media content is provided to users based on their personal artistic tastes without the need for the user to specifically search, select and download the desired content. The method of the invention collects information about a target object located proximately to a user and collects information about the interaction between the user and the target object, such as how long the user is in proximity to the object. The collecting of information about the target object located proximately to a user and collecting information about the interaction between the user and the target object are preferably performed by a mobile application. The target object may comprise an artistic work and the information collected about the artistic work comprises the nature of the work. The nature of the artistic work may be facts such as the title of the artistic work, the type of the artistic work, the artistic style of the artistic work, the medium of the artistic work, and the author of the artistic work. The method then queries a database containing digital media content using the information collected about the target object and the interaction between the user and the target object to identify digital media content to be delivered to the user. The querying of the database attempts to identify other artistic works that are at least similar to at least one artistic work that the user remained in proximity to longer than at least one other artistic work. The identified digital media content is then delivered to the user, such as by transmitting to a wireless digital media display device. The digital display device can be a computer, a screen saver, a mobile device, an online storage system, a wireless photo frame, a wireless television.

Another embodiment of the invention is a system for providing digital media content to users based on their personal artistic tastes that has a data collection system associated with the user that is programmed to collect information about a target object. A location system is programmed to collect information about how long the user is positioned in proximity to the target object. A server is programmed to receive the information about the target object and the information about how long the user is positioned in proximity to the target object. The server is also programmed to query a digital content database using the received information to retrieve digital content that is at least similar to the target object, and to deliver the retrieved digital content to a digital display device of the user. The data collection system and location system are preferably implemented at least in part on a mobile computing device as a mobile application. The target object is an artistic work and is associated with a tag containing information about the artistic work. The tag of the artistic work reports on any of the title of the artistic work, the type of the artistic work, the artistic style of the artistic work, the medium of the artistic work, and the author of the artistic work. The digital content database contains digital media content tagged with information corresponding to the target object information.

An additional embodiment of the invention comprises a computer program product for providing digital media content to users based on their personal artistic tastes, the computer program product comprising a computer readable storage medium having program instructions embodied therewith, the program instructions executable by a computing device to cause the computing device to collect information about a target object located proximately to a user, to collect information about the interaction between the user and the target object, to query a database containing digital media content using the information collected about the target object and the interaction between the user and the target object to identify digital media content to be delivered to the user, and to deliver the identified digital media content to the user.

### BRIEF DESCRIPTION OF THE DRAWINGS

The present invention will be more fully understood and appreciated by reading the following Detailed Description in conjunction with the accompanying drawings, in which:

FIG. 1 is a schematic of an environment for delivering media to a user based on the interaction of the user with certain objects;

FIG. 2 is a flowchart of a process for delivering media to a user based on the interaction of the user with certain objects; and

FIG. 3 is a block diagram of a system for delivering media to a user based on the interaction of the user with certain objects.

### DETAILED DESCRIPTION

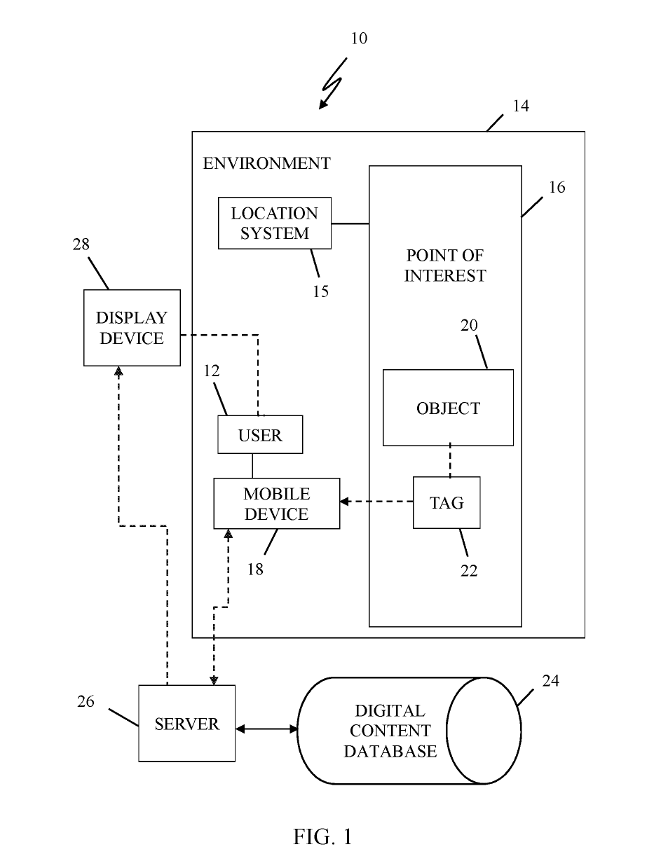

Referring now to the drawings, wherein like reference numerals refer to like parts throughout, there is seen in FIG. 1 a system 10 for delivering media to a user 12 based on the interaction of user 12 with the environment 14. System 10 collects information from user 12 when user 12 interacts with environment 14, such as when user 12 visits a point of interest 16, such as a cultural point of interest, museum, stadium, restaurant, store, billboard, etc. System 10 may reside on or have a component residing on a mobile device 18 of user 12, such as a local mobile application on a smartphone, to track the interactions of user 12 with the particular environment 14, such as by collecting data from target objects 20 positioned in environment 14. For example, a particular piece of artwork located in a museum may be associated with a wireless tag 22 that provides or broadcasts information about the particular nature of the artwork, such as keywords identifying or related to facts such as the title of the work, the type of the work, the artistic style of the work, the medium of the work, and the author of the work, etc. Tag 22 may comprise read-only device, such as an RFID tag that can be read by mobile device 18 having an RFID chip that is operated by the local portions of system 10.

System 10 may also collect information about any interaction between user 12 and target object 20 associated with tag 22, such as the amount of time user 12 spends in proximity to target object 20, and thus is likely viewing the work, either absolutely or in reference to other object 20 that are also associated with tags 22. For example, environment 14 may include a location system 15 that can determine the proximity of a user to tag 22 and then broadcast that information to mobile computer device 18 through tag 22. Acceptable technology for determining this information includes Bluetooth® Low Energy (BLE) or indoor location middleware such as IBM® Presence Insights. Alternatively, mobile device 18 of user may be used to determine the location of user 12, such as with its onboard global positioning system (GPS), and to collect the information needed to determine whether user 12 prefers certain artistic pieces in a given location or repeatedly visits certain locations or artistic works based on how many times user 12 visits a given location or how much time the user 12 spends in proximity to a given work.

Once information about the interaction of user 12 with target object 22, such as the estimated personal artistic tastes of user 12, have been gleaned by system 10, system 10 may then use the information collected from tag 22 and from the interaction of user 12 with environment 14 to retrieve digital content that is the same as or similar to the artwork that user 12 has demonstrated a predetermined amount of interaction with in environment 14. For example, system 10 may retrieve one or more digital images of the particular work, images of other artwork having attributes that at least partially match the information broadcast by tag 22, videos about the artwork, etc. from a digital media content database 24 using a server 26. The digital content could also comprise other types of media, such as pictures of advertisements, video commercials, etc. System 10 may thus be implemented in part as a remote service or server in communication with the application on mobile device 18. System 10 may search content database 24 using the keywords or other information gleaned from tags 22 visited by user 12. The search routine may be optimized as desired by user 12 or by the host of system 10, such as by limiting the search to keywords that are common across multiple tags 22 visited by user 12 during a predetermined time period, or by weighting the relevant keywords based on the amount of time that user 12 spent in proximity to the particular tag 22 that supplied the keyword, such as by applying a higher weight to a longer period of time spent in proximity. Thus, system 10 is able to use facts about the artwork that user 12 has visited more frequently or spent more time in proximity than average time user 12 spent in proximity to other locations 16 (or any other threshold), and thus is presumed to prefer over other artwork, to query content database 24 to find other content that user 12 might also like. System 10 may also select relevant content from content database 24 using existing machine learning recommendation algorithms, such as movie or book recommendation systems offered by conventional web sites, where the time spent by user 12 in proximity to tag is a proxy for a rating.

Once the digital content has been retrieved, system 10 may then deliver that content to user 12 via existing communication pathways, such as the internet. User 12 may predesignate a particular display device 28 to receive content from system 10, such as a wireless digital picture frame located at the home of user 12, so that system 10 can automatically transmit the digital content directly to display device 28. It should be recognized that display device 28 could be any networked device or application thereon, including computers, screen savers, mobile devices (such as mobile device 18), online storage systems, wireless photo frames, wireless televisions, etc. System 10 may also be configured to provide user 12 with a list of the stored content in content database 24 that is determined to be relevant to user 12 based on the information collected from tag 22 and user 12 so that user 12 can select what content will be delivered to display device 28. Alternatively, user 12 could configure display device 28 to retrieve content from system 10 according to a predetermined schedule or only in response to the authorization of user 12. System 10 may thus function as an online image storage provider that returns recommended images for display device 28 of user 12 without user 12 needing to manually search for, select, retrieve, or upload the desired content. Content database 24 may comprise a proprietary catalog of digital content or a third party database that is free or that requires a license. In the event that a fee is charged for content, the incurring of costs may be preapproved by user 12 or accomplished on an ad hoc basis by providing user 12 with the option to individually purchase content selected from content database 24.

As an example, user 12 may appreciate art and have a smart photo frame in a home living room. User 12 visits a local art museum three times a year and other museums three times a year. Within the museums, user 12 usually walks through all the displays, but tends to spend most of his or her time within the “Impressionist” area of the museums. User 12 also spends more than average time in the “Modern” area as well. Within the “Impressionist” area, user 12 also tends to spend more time viewing Monet paintings than those of other artists. System 10 may thus determine the preferences of user 12 based on the tags associated with the art pieces that provide the relevant facts of “Modern” as the general nature of the work, “Impressionist” as the style of the work, and Monet as the name of the author/artist, and then prioritize the preferences of user 12 to select and automatically deliver images of that or other Monet paintings to the living room photo frame of user 12, including images of paintings that are not found in the museums frequented by user 12.

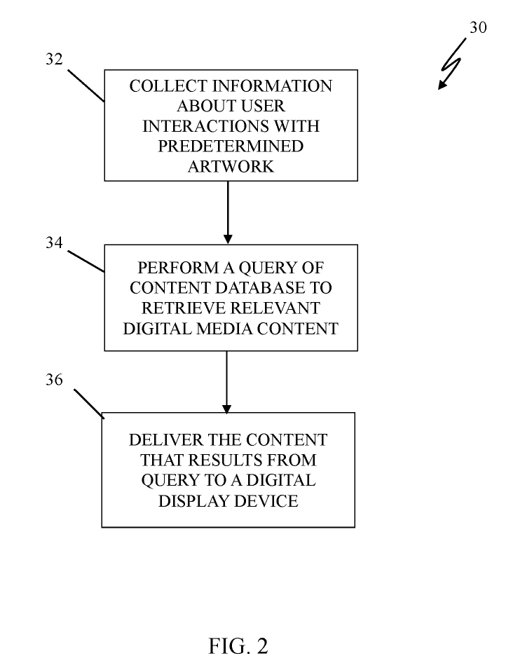

Referring to FIG. 2, system 10 implements a method 30 that may be implemented across server 26 and digital content database 24. Method 30 begins with the step of server 26 collecting information 32 about user interactions with predetermined artwork, such as by receiving data from mobile device 18. Next, server 26 performs a query 34 of content database 24 to retrieve relevant digital media content that corresponds to or at least partially matches the behavior of user 12 with respect to predetermined artwork 32. Finally, server 26 delivers the content 36 that results from query 34 to a digital display device 28 of user 12, such as a wireless digital frame.

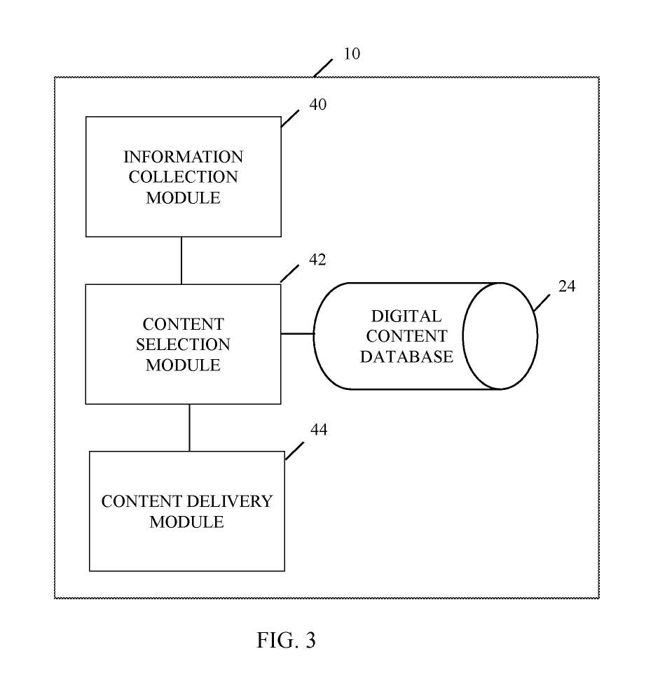

Referring to FIG. 3, system 10 includes an information collection module 40 programmed to collect information 32 about user interactions with predetermined objects or locations of interest, such as artwork. Information collection module 40 is preferably located remotely, such as in an application residing on a user mobile device. System 10 further includes a content selection module 42 that is programmed to query content database 24 based on the information collected by first module 40 and provided or transmitted for content selection module 42 so that content selection module 42 can uncover additional digital media that might be of interest to user 12 based on the user interactions with predetermined artwork. Finally, a content delivery module 44 is programmed to deliver the additional digital media uncovered by content selection module 42 to the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of providing digital media content to users, comprising the steps of:
collecting information about a target object located proximately to a user;
collecting information about the interaction between the user and the target object;
querying a database containing digital media content using the information collected about the target object and about the interaction between the user and the target object to identify digital media content to be delivered to the user; and
delivering the identified digital media content to the user.

2. The method of claim 1, wherein the target object comprises an artistic work and the information collected about the artistic work comprises a nature of the work.

3. The method of claim 2, wherein the nature of the work comprises at least one fact selected from the group consisting of a title of the artistic work, a type of the artistic work, an artistic style of the artistic work, a medium of the artistic work, and an author of the artistic work.

4. The method of claim 1, wherein the steps of collecting information about a target object located proximately to a user and collecting information about the interaction between the user and the target object are performed by a mobile application that reads a tag associated with the target object.

5. The method of claim 1, wherein the step of collecting information about the interaction between the user and the target object comprises collecting information about how long the user is positioned in proximity to the target object.

6. The method of claim 1, wherein the step of querying a database containing digital media content using the information collected about the target object and the interaction between the user and the target object to identify digital media content to be delivered to the user comprises the step of querying the database to identify a plurality of other artistic works that are at least similar to at least one artistic work that the user remained in proximity to longer than at least one other artistic work.

7. The method of claim 1, wherein the step of delivering the identified digital media content to the user comprises transmitting the identified digital media content to a digital display device of the user.

8. A system for providing digital media content to users, comprising:
a data collection system associated with the user that is programmed to collect information about a target object;
a location system programmed to collect information about how long the user is positioned in proximity to the target object; and
a server programmed to receive the information about the target object and the information about how long the user is positioned in proximity to the target object, to query a digital content database using the received information to retrieve digital content that is related to the target object, and to deliver the retrieved digital content to a predetermined digital display device of the user.

9. The system of claim 8, wherein the data collection system and location system are implemented in part on a mobile computing device as a mobile application.

10. The system of claim 9, wherein the target object comprises an artistic work that is associated with a tag containing information about the artistic work.

11. The system of claim 10, wherein the information about the artistic work comprises at least one fact selected from the group consisting of a title of the artistic work, a type of the artistic work, an artistic style of the artistic work, a medium of the artistic work, and an author of the artistic work.

12. The system of claim 8, wherein the predetermined digital display device is selected from the group consisting of a computer, a screen saver, a mobile device, an online storage system, a wireless photo frame, a wireless television.

13. The system of claim 8, wherein the digital content database contains digital media content tagged with information corresponding to the target object information.

14. A computer program product for providing digital media content to users, the computer program product comprising a computer readable storage medium having program instructions embodied therewith, the program instructions executable by a computing device to cause the computing device to:
collect information about a target object located proximately to a user;
collect information about the interaction between the user and the target object;
query a database containing digital media content using the information collected about the target object and the interaction between the user and the target object to identify digital media content to be delivered to the user;
deliver the identified digital media content to the user.

15. The computer program product of claim 14, wherein the target object comprises an artistic work and the information collected about the artistic work comprises the nature of the work.

16. The computer program product of claim 15, wherein the nature of the artistic work comprises at least one fact selected from the group consisting of a title of the artistic work, a type of the artistic work, an artistic style of the artistic work, a medium of the artistic work, and an author of the artistic work.

17. The computer program product of claim 14, wherein the computer program product that causes the computing device to collect information about a target object located proximately to a user and to collect information about the interaction between the user and the target object is a mobile application.

18. The computer program product of claim 14, wherein the interaction between the user and the target object comprises information about how long the user is positioned in proximity to the target object.

19. The computer program product of claim 14, wherein the information collected about the target object and the interaction between the user and the target object is used to identify digital media content to be delivered to the user by querying the database to identify other artistic works that are at least similar to at least one artistic work that the user remained in proximity to longer than at least one other artistic work.

20. The computer program product of claim 14, wherein the identified digital media content is delivered to the user by transmitting the identified digital media to a digital display device of the user.
